(19) United States
(12) Patent Application Publication
(10) Pub. No.: US 2007/0288970 A1
(43) Pub. Date: Dec. 13, 2007

(54) METHOD AND APPARATUS FOR SHARING TV CONTENT WITH A REMOTE DEVICE

(76) Inventor: Mats Tedenvall, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/420,054

(22) Filed: May 24, 2006

Related U.S. Application Data
(60) Provisional application No. 60/747,011, filed on May 11, 2006.

(51) Int. Cl. H04N 7/173

(52) U.S. Cl. 725/86

(57) ABSTRACT

A method of sharing television (TV) content with a remote device includes receiving a signal or data representative of TV content. In response to a user command, the mobile phone selects a portion of TV content to be sent to a remote device. A message including the selected TV content is created or otherwise triggered and sent to a remote device. The mobile phone and associated application program allows a user to share easily a TV moment while continuing to watch TV on the mobile phone.

### RELATED APPLICATION DATA

This application claims priority of U.S. Provisional Application No. 601747,011, filed on May 11, 2006, which is incorporated herein by reference in its entirety.

### TECHNICAL FIELD OF THE INVENTION

The present invention relates generally to portable communication devices, and, more particularly, to a portable communication device and method for sharing TV content with a remote device.

### DESCRIPTION OF RELATED ART

In recent years, portable communication devices, such as mobile phones, personal digital assistants, mobile terminals, etc., continue to grow in popularity. As the popularity of portable communication devices continues to grow, today's wireless landscape is rapidly changing as mobile phones and networks are being enhanced to provide features and services beyond voice communications. The wireless industry is experiencing a rapid expansion of mobile data services. In addition, the features associated with certain types of portable communication devices have become increasingly diverse. To name a few examples, many portable communication devices have cameras, text messaging capability, Internet browsing functionality, electronic mail capability, video playback capability, audio playback capability, image display capability and hands-free headset interfaces.

Recently, some portable communication devices have been equipped with television (TV) applications in which TV content can be received by the portable communication device and viewed on the portable communication device by the user.

### SUMMARY

In view of the foregoing, a need exists for a portable communication device that includes additional mobile data services and functionality, and application programs for providing additional mobile data services and functionality, such as a portable communication device and associated application program for sharing TV content with a remote device.

One aspect of the invention relates to a method of sharing TV content with a remote device. The method includes receiving a signal or data representative of TV content, in response to a user command, selecting a portion of the TV content to be sent, and triggering a multimedia message to be sent to the remote device, where the multimedia message includes the selected portion of the TV content.

According to another aspect, the triggering includes creating a multimedia message including the selected portion of the TV content.

According to another aspect, the triggering includes interfacing with an Multimedia Messaging Service (MMS) application to send a message including the selected portion of the TV content.

According to another aspect, the multimedia message is an MMS message or an e-mail message.

According to another aspect, the selected portion of the TV content includes a snapshot of the TV content.

According to another aspect, receiving includes receiving a TV signal over the air and converting the TV signal into TV video data.

According to another aspect, receiving includes receiving streaming video representative of TV content.

According to another aspect, the method further comprises recording the selected portion of the TV content.

According to another aspect, triggering a multimedia message to be sent to the remote device does not interrupt display of the TV content.

According to another aspect, the method further comprises automatically storing the last X minutes of received TV content, where X is a predetermined value.

According to another aspect, the multimedia message includes the last Y seconds of TV content viewed by the user, where Y is a predetermined value or a user-selectable value.

According to another aspect, the multimedia message includes electronic program guide (EPG) data related to the TV content.

Another aspect of the invention relates to a program stored on a machine readable medium, the program being suitable for use in a portable communication device, wherein when the program is loaded in memory in the portable communication device and executed causes the portable communication device to: receive a signal or data representative of TV content, select a portion of the TV content to be sent to a remote device in response to a user command, and send a multimedia message including the selected portion of the TV content.

According to another aspect, the multimedia message is an MMS formatted message or an e-mail message.

According to another aspect, the program causes the portable communication device to automatically store the last X minutes of received TV content, where X is a predetermined value.

According to another aspect, the program causes the portable communication device to send a multimedia message that includes the last Y seconds of TV content viewed by the user, where Y is a predetermined value or a user-selectable value.

According to another aspect, the portable communication device is a mobile phone.

According to another aspect, a portable communication device comprises a memory and a processor that executes an application program within the memory that causes the portable communication device to: receive a signal or data representative of TV content, select a portion of the TV content to be sent to a remote device in response to a user command, and send a multimedia message including the selected portion of the TV content.

Another aspect of the invention relates to a portable communication device that includes a receiver for receiving a signal or data representative of TV content, and a program stored in a memory, where the program triggers a multimedia message to be sent to a remote device, and the multimedia message includes a user-selected portion of the TV content.

According to another aspect, the portable communication device is a mobile phone.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of a communication system including a portable communication device on which aspects of the present invention are carried out;

FIG. 2 is a diagrammatic illustration of a portable communication device on which aspects of the present invention are carried out;

FIG. 3 is a flow chart or diagram representing the relevant operation of a portable communication device in accordance with an embodiment of the present invention;

FIG. 4 is a flow chart or diagram representing the relevant operation of a portable communication device in accordance with an embodiment of the present invention; and

FIG. 5 is a flow chart or diagram representing the relevant operation of a portable communication device in accordance with an embodiment of the present invention.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

As used herein, the term “portable communication device” includes portable radio communication equipment. The term “portable radio communication equipment”, which herein after may be referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of electronic equipment capable of being used in connection with a television (TV) application.

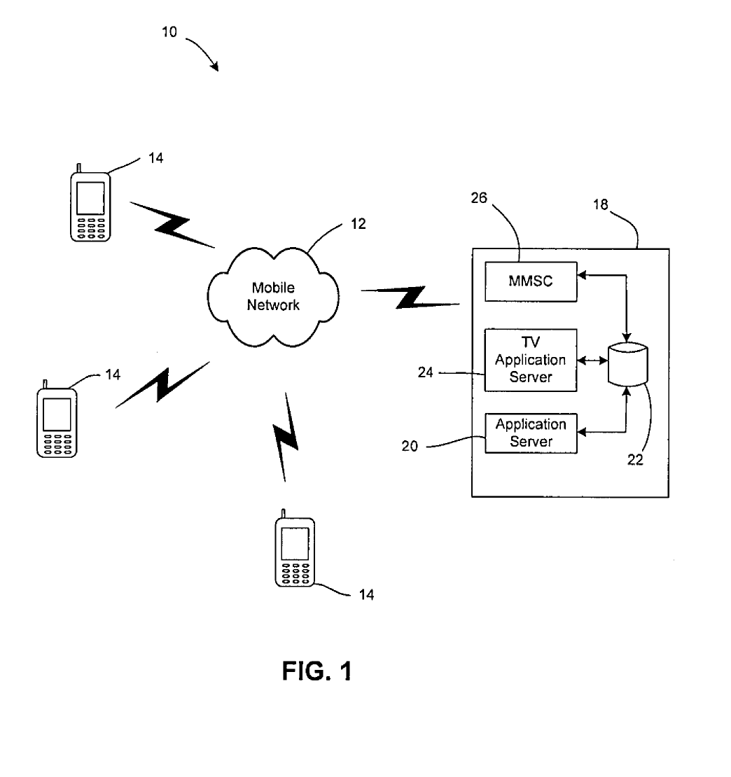

Referring initially to FIG. 1, a communication system 10 includes a mobile network 12, such as a mobile cellular telephony network, that facilitates communication, such as voice communication and/or data transfer between a plurality of portable communication devices 14, such as mobile phones, mobile terminals or the like. The communication system 10 and at least one of the portable communication devices 14 support a TV application, e.g., by including appropriate hardware and/or application programs for receipt and processing of signals and/or data representative of TV content. For purposes of the discussion contained herein, portable communication device 14 will be described in terms of sharing or otherwise transmitting TV content with one or more other portable communication devices or some other remote device.

The communication system 10 includes a network infrastructure 18, portions of which are used or otherwise accessed by the portable communication devices in connection with aspects of the invention. The portable communication devices 14 may interact with each other and/or the network infrastructure in accordance with any suitable communication standard, including, but not limited to, Advanced Mobile Phone Service (AMPS), Digital Advanced Mobile Phone Service (D-AMPS), General Packet Radio Service (GPRS), Universal Mobile Telecommunications System (UMTS), Global System for Mobile Communications (GSM), Code Division Multiple Access (CDMA), Voice-Over IP (VoIP), Session Initiated Protocol (SIP), Wireless Local Area Network (WLAN) or the like. In other words, the communication system is shown in FIG. 1 for purposes of explaining aspects of the present invention, without limiting the invention to a particular communication system design, architecture or communication standard.

The network infrastructure 18 includes one or more application servers, which are indicated generally by the numeral 20, and a storage device 22, such as a memory for storing data accessible or otherwise usable by the application servers 20. The network infrastructure 18 depicted in FIG. 1 includes a TV application server 24, e.g., an application server suitable for providing TV content to the portable communication device 14, and a Multimedia Messaging Service Center (MMSC) 26, which is used in connection with the exchange of Multimedia Messaging Service (MMS) formatted messages (also referred to simply as MMS messages). It will be appreciated that the TV application server can include any TV network or infrastructure, including, but not limited to Digital Video Broadcasting-Terrestrial (DVB-T), Digital Video Broadcasting-Handheld (DVB-H), Terrestrial-Digital Multimedia Broadcasting (T-DIMB), Digital Multimedia Broadcasting for Television (DMB-T), Integrated Services Digital Broadcasting-Terrestrial (IS DB-T), Multimedia Broadcast/Multicast Service (MBMS), 3G Streaming, Media FLO and the like. The application servers 20, including the TV application server 24 and the MMSC 26, arc computer servers that serve different functions in the communication system. As is described more fully below, one or more of the portable communication devices 14 are operable share quickly or otherwise transmit quickly a user-selected TV clip to a remote device.

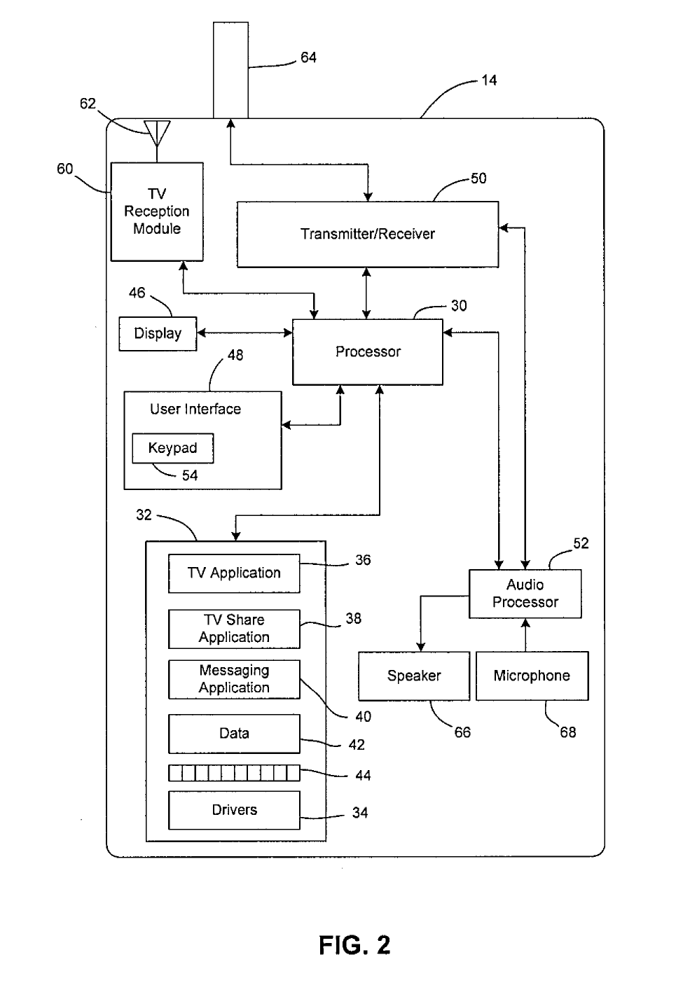

FIG. 2 represents a functional block diagram of a portable communication device 14 in accordance with aspects of the present invention. The portable communication device 14 includes a processor 30 for controlling the overall operation of the portable communication device. The processor 30 may be any commercially available or custom microprocessor. Memory 32 is operatively connected to the processor 30 for storing control programs and data used by the portable communication device. The memory 32 is representative of the overall hierarchy of memory devices containing software and data used to implement the functionality of the portable communication device in accordance with aspects of the present invention.

In the illustrated embodiment, memory 32 stores device drivers 34, e.g., I/O device drivers, application programs, including a TV application 36, a TV share application 38 (also referred to as a TV share processor), a messaging application 40, e.g., an application that facilitates the exchange of MMS messages, e-mails or the like, and application program data 42, including one or more memory buffers 44 in which portions of TV content may be stored for time-shifted access. The I/O device drivers include software routines that are accessed through the processor 30 (or by an operating system (not shown) stored in memory 32) by the application programs, including the TV share application program 38, to communicate with devices such as the display 42 and other input/output ports.

The application programs, including the TV share application program 38, comprise programs that implement various features of the portable communication device 14, such as e-mail, Internet access, contact manager and the like. As is discussed more fully below, the TV share application program 38 comprises a program that facilitates quickly sharing or otherwise transmitting user-selected TV clips with a remote device, e.g., another portable communication device, a remote computer or the like.

A person having ordinary skill in the art of computer programming, and specifically in applications programming for mobile phones, will consider it obvious in view of the description provided herein how to program a mobile phone to operate and carry out the functions described herein with respect to the TV share application program 38 (and any interfacing between the TV share application program 38 and other application programs, e.g., the TV application program 36 and the messaging application program 40). Accordingly, details as to specific programming code have been left out for the sake of brevity. Also, while the TV share functionality is carried out via the processor 30 and TV share application program 38 (alone or in conjunction with other application programs) in memory 32 in accordance with aspects of the invention, such function could also be carried out via dedicated hardware, firmware, software or combinations thereof without departing from the scope of the present invention.

With continued reference to FIG. 2, the processor 30 interfaces with the display 46, a user interface unit 48, a transmitter/receiver 50 (often referred to as a transceiver) and audio processing circuitry, such as an audio processor 52, e.g., an audio processing circuit. In the illustrated embodiment, the user interface unit 48 includes or is operatively coupled to a keypad 54. Of course, the user interface unit may include other actuators or input devices that allow the user to interact with the mobile phone. For example, keypad 54 allows the user to dial numbers, enter commands and data, and select options. The display 46 allows the user to view a variety of information, such as dialed digits, stored information, and output from various applications, including the TV and TV share application programs 36 and 38.

Optionally, the mobile phone includes a TV reception unit 60, including an appropriate antenna 62. In this embodiment, the TV reception unit 60 and antenna 62 facilitate receiving TV signals transmitted over the air. The TV reception unit 60, alone or together with the TV application program 36 extract an appropriate TV image signal from the TV signal transmitted over the air. In another embodiment (in which the mobile phone may or may not include TV reception unit 60 and antenna 62), the mobile phone may receive signal data representative of TV content that is streamed or otherwise transmitted from a remote location, e.g., making use of a TV application server 24 (FIG. 1).

An antenna 64 is coupled to the transmitter/receiver 50 such that the transmitter/receiver 50 transmits and receives signals via the antenna 64, as is conventional. The portable communication device 14 includes an audio processor 52 for processing the audio signal transmitted by and received from the transmitter/receiver 46 (and/or signals received by TV reception unit 60 and antenna 62). Coupled to the audio processor 52 are a speaker 66 and microphone 68, which enable a user to listen and speak via the portable communication device.

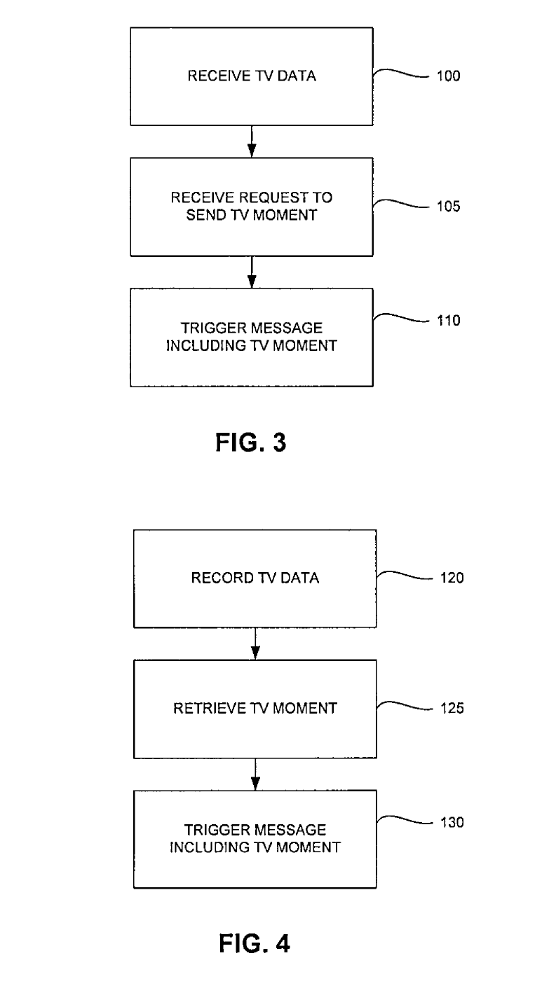

While for purposes of simplicity of explanation, the flow charts or diagrams in FIGS. 3-5 include a series of steps or functional blocks that represent one or more aspects of the relevant operation of the portable communication device 14, it is to be understood and appreciated that aspects of the present invention are not limited to the order of steps or functional blocks, as some steps or functional blocks may, in accordance with aspects of the present invention, occur in different orders and/or concurrently with other steps or functional blocks from that shown and described herein. Moreover, not all illustrated steps or functional blocks of aspects of relevant operation may be required to implement a methodology in accordance with an aspect of the invention. Furthermore, additional steps or functional blocks of aspects of relevant operation may be added without departing from the scope of the present invention.

Turning now to FIG. 3, a method of sharing TV content, e.g., a TV clip, a portion of a TV program, a TV snapshot or the like, begins at functional block 100 where the mobile phone receives TV data. In one embodiment, receiving TV data includes receiving TV signals transmitted over the air, e.g., using an antenna 62 and a TV reception unit 60 (FIG. 2). The mobile phone software and hardware may interface to extract an appropriate TV image signal from the TV signal transmitted over the air. Alternatively, receiving TV data may include receiving a video data signal from an appropriate content source, e.g., a TV application server 24 or TV network (FIG. 1), in a streaming video or time-shifted fashion. As the user is viewing the TV content represented by the received TV data, e.g., a TV program, at functional block 105, the mobile phone may receive a request from the user to send a TV moment, e.g., a TV clip or portion of a TV program being viewed by the user or a snapshot of a TV show being viewed. The user can signal or otherwise command the mobile phone by pressing or otherwise actuating the appropriate button on the mobile phone, e.g., by pressing a dedicated “Send TV Moment” button or pressing another appropriate soft key to initiate the functionality provided by the TV share program.

At functional block 110, a message is created or otherwise triggered including the user-selected TV moment or TV clip. In one embodiment, the mobile phone creates or otherwise triggers an MMS message including the user-selected TV moment, clip or content. Alternatively the mobile phone creates another type of multimedia message with the user-selected TV clip, such as an e-mail message. It will be appreciated that the TV share application program 38 may work alone or in conjunction with an appropriate messaging application, e.g., a message application program on or otherwise programmed into the mobile phone.

In one embodiment, upon receipt of a user command to send a TV moment, TV clip or the like, the mobile phone will automatically create or otherwise trigger an appropriate multimedia message including a TV moment made up of the last X seconds viewed by the user. In one embodiment, the clip will be made up of a predetermined time period, for example, the last ten seconds, the last twenty seconds, the last forty seconds or the like. Alternatively, upon receipt of a user command to send a TV moment, the TV share application program may prompt the user to enter what length of TV clip should be sent by way of the multimedia message. Sharing of TV content in this matter may be achieved because the mobile phone typically buffers the last Y minutes of TV content, e.g., consistent with time-shifting of TV content. The mobile phone may transmit a message, e.g., a multimedia message, including the desired TV clip while allowing the user to continue to watch TV on the mobile phone.

Referring now to FIG. 4, a method of sharing TV content, e.g., a TV clip, a portion of a TV program or the like, begins at functional block 120 where the mobile phone records TV data. In one embodiment, the recorded TV data corresponds to image data extracted from a TV signal transmitted over the air. Alternatively, the TV data is recorded from streaming or other video data transfer provided by an appropriate content source, e.g., a TV application server. At functional block 125, the mobile phone receives a request from the user to retrieve a TV moment. In one embodiment, the command to retrieve a TV moment or TV clip may be provided while the user is viewing a previously recorded TV program. Alternatively, the user may command the mobile phone to provide a menu of previously recorded TV clips. At functional block 130, the mobile phone creates or otherwise triggers a message, e.g., a multimedia message, to be sent including the desired TV moment or TV clip. As discussed above with reference to FIG. 3, creating or otherwise triggering a multimedia message can include, but is not limited to, an MMS message, an e-mail message or the like.

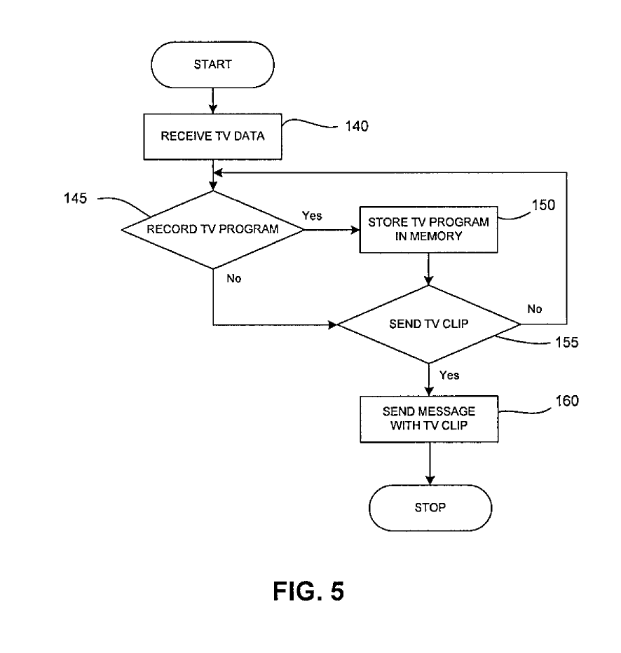

Referring now to FIG. 5, an exemplary embodiment of a method of sharing TV content with a remote device is provided. The method begins at functional block 140, where TV data is received by the mobile phone. As is discussed above, receiving TV data can include receiving a TV signal over the air and extracting TV image data from the signal received over the air. Alternatively, receiving TV data may include a video data signal from a content source, e.g., a TV application server, in a streaming fashion. At functional block 145, the user has the option of recording the received TV program, or a portion thereof. If the user wishes to record some or the entire TV program, the user may command the mobile phone to store the TV program in memory (functional block 150). Regardless of whether the user wishes to record the TV program the user has the option of sending a TV clip at functional block 155. The clip can be based on TV data as received, e.g., a portion of which will be stored in an appropriate memory buffer, or from a TV program or portion thereof already recorded or otherwise stored in memory. If the user wishes to send a TV clip, the mobile phone will create or otherwise trigger a message, e.g., a multimedia message, including the desired TV clip (functional block 160). As is discussed above, the multimedia message can include an MMS formatted message, and e-mail message or the like.

While the present invention is being described with respect to sharing TV content, it will be appreciated that the methodology described herein may be applicable to sharing of other media content, including, but not limited to, received or prerecorded video content, images, audio content, data files and the like. In addition, as described above, creating or otherwise triggering a message with a TV clip may include the triggering or prompting of any other application program, e.g., a messaging application program loaded or otherwise running on the mobile phone, to take an appropriate action in accordance with the functionality associated with the specific application program being triggered.

In one embodiment, the message, e.g., the multimedia message, including the desired TV clip may be transmitted along with other information or data. For example, each multimedia message may include information regarding the TV clip transmitted in the multimedia message. Such information can include information from or portions of an electronic program guide (EPG) that corresponds to the program being transmitted. Suitable EPG information may include the title of the program, the time and date at which the program originally aired, a brief description of the program or portion of the program being transmitted and the like.

It will be appreciated that a mobile phone having the capability of sharing a TV clip without interrupting the user's watching of a TV program provides the user with additional convenience and enhanced mobile phone functionality. By way of example, and in no way limiting the embodiments described herein, the user may wish to send a funny clip to a friend by itself or along with a message, such as, “you should check this program out; it is on right now.” Alternatively, by transmitting a TV clip while watching a TV program, the user can share a TV clip while the clip is fresh in the user's mind. This TV sharing functionality should prove useful to avoid a user saying to a friend, “did you happen to see that crazy play last night?” Instead, the user can share the TV clip, and say, “did you see the clip that I sent you showing that crazy play last night?” One of ordinary skill in the art will appreciate that the method and device described herein with reference to exemplary embodiments will lend itself of a variety of other applications that are contemplated to be within the scope of the present invention.

As will be appreciated by one of skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A method of sharing TV content with a remote device, the method comprising:
receiving a signal or data representative of TV content;
in response to a user command, selecting a portion of the TV content to be sent; and
triggering a multimedia message to be sent to the remote device, the multimedia message including the selected portion of the TV content.

2. The method according to claim 1, wherein triggering includes creating a multimedia message including the selected portion of the TV content.

3. The method according to claim 1, wherein triggering includes interfacing with an Multimedia Messaging Service (MMS) application to send a message including the selected portion of the TV content.

4. The method according to claim 1, wherein the multimedia message is an MMS message or an e-mail message.

5. The method according to claim 1, wherein the selected portion of the TV content includes a snapshot of the TV content.

6. The method according to claim 1, wherein receiving includes receiving a TV signal over the air and converting the TV signal into TV video data.

7. The method according to claim 1, wherein receiving includes receiving streaming video representative of TV content.

8. The method according to claim 1, further comprising recording the selected portion of the TV content.

9. The method according to claim 1, wherein triggering a multimedia message to be sent to the remote device does not interrupt display of the TV content.

10. The method according to claim 1, further comprising automatically storing the last X minutes of received TV content, where X is a predetermined value.

11. The method according to claim 10, wherein the multimedia message includes the last Y seconds of TV content viewed by the user, where Y is a predetermined value or a user-selectable value.

12. The method according to claim 1, wherein the multimedia message includes electronic program guide (EPG) data related to the TV content.

13. A program stored on a machine readable medium, the program being suitable for use in a portable communication device, wherein when the program is loaded in memory in the portable communication device and executed causes the portable communication device to:
receive a signal or data representative of TV content;
select a portion of the TV content to be sent to a remote device in response to a user command; and
send a multimedia message including the selected portion of the TV content.

14. The program according to claim 13, wherein the multimedia message is an MMS formatted message or an e-mail message.

15. The program according to claim 13, wherein the program causes the portable communication device to automatically store the last X minutes of received TV content, where X is a predetermined value.

16. The program according to claim 15, wherein the program causes the portable communication device to send a multimedia message that includes the last Y seconds of TV content viewed by the user, where Y is a predetermined value or a user-selectable value.

17. The program according to claim 13, wherein the portable communication device is a mobile phone.

18. A portable communication device comprising a memory and a processor that executes an application program according to claim 13 within the memory.

19. A portable communication device comprising;
a receiver for receiving a signal or data representative of TV content;
a program stored in a memory, where the program triggers a multimedia message to be sent to a remote device, the multimedia message including a user-selected portion of the TV content.

20. The portable communication device according to claim 19, wherein the portable communication device is a mobile phone.
